(19) United States
(12) Patent Application Publication
(10) Pub. No.: US 2024/0334504 A1
(43) Pub. Date: Oct. 3, 2024

(54) METHODS AND SYSTEMS FOR DATA FLOW COORDINATION IN MULTI-MODAL COMMUNICATIONS

(71) Applicant: InterDigital Patent Holdings, Inc., Wilmington, DE (US)

(72) Inventors: Catalina Mladin, Hatboro, PA (US); Michael Starsinic, Newtown, PA (US); Quang Ly, North Wales, PA (US); Jiwan Ninglekhu, Royersford, PA (US); Pascal Adjakple, Great Neck, NY (US); Kyle Jung-Lin Pan, Saint James, NY (US)

(73) Assignee: InterDigital Patent Holdings, Inc., Wilmington, DE (US)

(21) Appl. No.: 18/693,910

(22) PCT Filed: Oct. 11, 2022
(86) PCT No.: PCT/US22/77899

§ 371 Date: Mar. 20, 2024

Related U.S. Application Data
(60) Provisional application No. 63/254,418, filed on Oct. 11, 2021.

(51) Int. Cl. H04W 76/10; H04W 40/02

(52) U.S. Cl. CPC H04W 76/10; H04W 40/02

(57) ABSTRACT

Method and apparatus are for coordinating data flows from multiple user apparatuses, WTRUs, in a coordinated communication group. A method comprising receiving, by a non-access stratum, NAS, layer of a wireless transmit/receive unit, WTRU, and from an application server, a coordination identifier; sending, by the WTRU and to a core network entity, a request to establish a protocol data unit, PDU, session, wherein the request comprises the coordination identifier; receiving, by the WTRU, configuration information associated with the coordination identifier and the PDU session, wherein the configuration information comprises one or more rules associated with the PDU session that are to be coordinated with one or more rules associated with other PDU sessions; and receiving, by the WTRU, from the core network entity, a message indicating establishment of the PDU session.

### CROSS-REFERENCE TO RELATED APPLICATIONS

This application claims the benefit of U.S. Patent Application No. 63/254,418, filed Oct. 11, 2021.

### BACKGROUND

In legacy third generation partnership project (3GPP) systems, support for coordination and synchronization of the processing, delivery, or transmission timing, or the data forwarding treatment of data streams across different user apparatuses (UEs) or within the context of a single UE may be limited. Accordingly, there is a need for improved coordination and synchronization of data streams and resource consumption among and across UEs in a network.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Methods and apparatuses are described herein for improving communication and communication coordination for single UEs and between multiple UEs in a wireless network. System enhancements may improve coordination of data flows among UEs to improve the coordination of resource consumption in a wireless network. System enhancements may also be provided for enabling UEs to assist with service-level synchronization for multi-modal services. Systems and methods are described for enabling data flows of multiple UEs to be associated in coordinated communication groups managed by application servers in a wireless network. Systems and methods are described for enabling UEs and the network to determine what UEs and which data flows may be part of a coordinated communication group. Systems and methods are described for enabling UEs to be provided with communication coordination rules and policies. Systems and methods are described for enabling UEs to evaluate triggers for the communication coordination rules and to apply the required coordination actions. Systems and methods are described for enabling UEs to provide assistance for service-level flow synchronization for multi-modal services.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example system.

FIG. 2A shows an example method.

FIG. 2B shows an example method.

FIG. 2C shows an example method.

FIG. 3 shows and example system and method.

FIG. 4 shows an example system and method.

FIG. 5 shows an example method.

FIG. 6 shows an example method.

FIG. 7A shows an example communications system.

FIG. 7B shows an example apparatus configured for wireless communications.

FIG. 7C shows an example system.

FIG. 7D shows an example system.

FIG. 7E shows an example system.

FIG. 7F shows an example system.

FIG. 7G shows an example system.

### DETAILED DESCRIPTION

Methods and apparatuses are described herein for coordinating data flows from multiple UEs and for enabling UEs to assist with service-level synchronization for multi-modal services.

The following abbreviations and definitions may be used herein:

| | |
|---|---|
| 3GPP | Third Generation Partnership Project |
| 5GS | 5G System |
| AAA | Authentication, authorization, and accounting |
| AF | Application Function |
| AMBR | Aggregate Maximum Bit Rate |
| AMF | Access and Mobility Management Function |
| AS | Application Server |
| CCG | Coordinated Communication Group |
| CSM | CCG Synchronization Markers |
| CN | Core Network |
| DL | Downlink |
| DNN | Data Network Name |
| GBR | Guarantee Bit Rate |
| GPSI | Generic Public Subscription Identifier |
| GUI | Graphical User Interface |
| NAS | Non-Access Stratum |
| PCF | Policy Control Function |
| PDU | Protocol Data Unit |
| QFI | QoS Flow Identifier |
| QoS | Quality of Service |
| RAN | Radio Access Network |
| RCM | Reflective Coordination Marker |
| RTT | Round Trip Time |
| RQA | Reflective QoS Attribute |
| Rx | Receive/reception |
| S-NSSAI | Single Network Slice Selection Assistance Information |
| SID | Study Item Description |
| SMF | Session Management Function |
| TACMM | Tactile and multi-modality (communications) |
| Tx | Transmit/transmission |
| UDM | Unified Data Management |
| UE | User Equipment |
| UL | Uplink |
| UP | User Plane |
| UPF | User Plane Function |
| URSP | User Route Selection Policy |
| VN | Virtual Network |

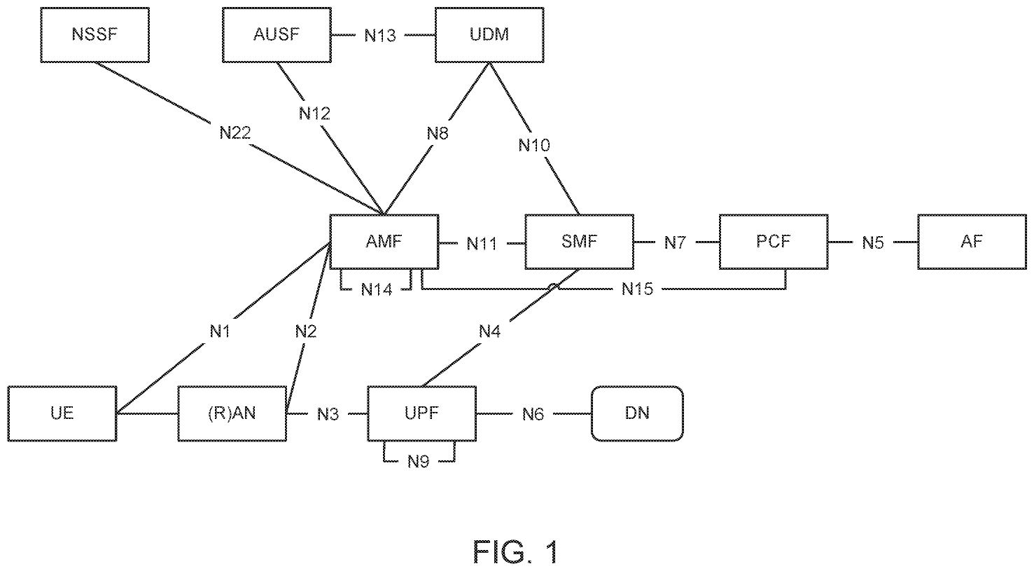

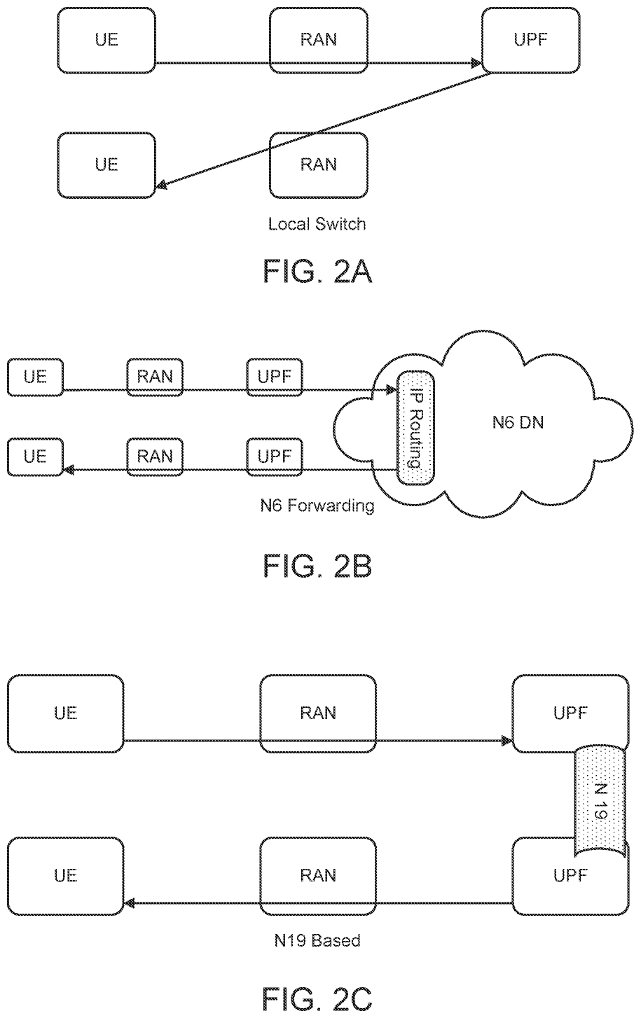

FIG. 1 shows a 3GPP 5G non-roaming system architecture in which various entities may interact with each other over indicated reference points. A User Equipment (UE) may communicate with a Core Network (CN) to establish control signaling and may enable the UE to use services from the CN. Examples of control signaling functions may comprise registration, connection and mobility management, authentication and authorization, session management, and the like.

FIG. 1 shows Network Functions (NFs) that may describe features of control signaling.

An Access and Mobility Function (AMF): The AMF may describe the UE sending an N1 message through a RAN node to the AMF to perform one or more control-plane signaling operations, comprising registration, connection management, mobility management, access authentication and authorization, and the like.

Session Management Function (SMF): The SMF may be responsible for session management comprising establishing PDU sessions to allow UEs to send data to Data Networks (DNs) such as the internet or to an application server and other session management related functions.

Policy and Control Function (PCF): The PCF may provide a policy framework governing network behavior, and the PCF may access subscription information to make policy decisions.

Authentication Server Function (AUSF): The AUSF may support authentication of UEs for 3GPP and untrusted non-3GPP accesses.

Unified Data Management (UDM): The UDM may support generation of 3GPP AKA Authentication Credentials, user identification handling, subscription management, and the like.

Network Slice Selection Function (NSSF): The NSSF may comprise aspects of network slice management such as selection of network slice instances for UEs, management of NSSAIs, and the like.

Radio Access Network (RAN): The RAN node may offer communication access from the UE to the core network for one or more of control plane communications or user plane communications.

A virtual network (VN) may be used by UEs using private communication which may be organized as a 5G VN group. The 5G VN group member UEs may be identified by an External Group ID and an Internal Group ID. Each group member UEs may be associated with a list of GPSI's (External UE ID's). Other 5G VN Group Data configuration may comprise: PDU session type, DNN, S-NSSAI, Application descriptor. This information may be provisioned by at least one of an AF or via the OAM system.

The group information may be configured and/or modified. The PCF may notify each UE in the group about the new information. The UE configuration update procedure may be used to send updated URSP rules to the UE. Based on URSP rules, the UE may determine that when the traffic matches the given Application Descriptor, the UE should use the given PDU Session, DNN, S-NSSAI combination. The UE does not need to be informed of the Group Identifier.

A UE may be authorized access to the VN as follows: The network may associate the DNN with the Group. The UE may establish a PDU Session to the DNN and may trigger secondary PDU Session authentication as described in TS 23.501 clause 5.6.6 and TS 23.502 clause 4.3.2.3.

The PDU Session may provide one or more of unicast or multicast communication for a DNN associated to a 5G VN group. The UPF may determine whether the communication is for unicast or multicast based on the destination address of the received data.

Three traffic forwarding methods may be available for 5G VN communication as follows: N6 Based, N19 Based and Local Switching.

Service Data Flow detection may assist in determining the traffic that belongs to individual flows, which may be handled based on various QoS levels and may use the service data flow template available in a PCC Rule provided by the PCF. Templates may define the traffic for the service data flow detection as a set of service data flow filters or an application identifier referring to an application detection filter. The SMF may map the template in the PCC Rule into the detection information in a Packet Detection Rule to the UPF. The SMF may map the template into the detection information in Packet Filter information for the UE. The SMF may derive the QoS Profiles for the RAN.

Each service data flow template may comprise any number of service data flow filters and may be applicable to uplink, downlink or both uplink and downlink. The application detection filters provided to the SMF may be extended with the PFDs provided by a third-party AF.

Each service data flow filter may comprise information about whether explicit signaling of the corresponding traffic mapping information to the UE is required.

The network may ensure that the traffic mapping information signaled to the UE reflects the PCC rules, except for those extending the inspection beyond what may be be signaled to the UE. The PCC rules may restrict what traffic is allowed compared to what is explicitly signaled to the UE. The PCF may, per service data flow filter, indicate that the SMF is required to explicitly signal the corresponding traffic mapping information to the UE.

The SMF may be responsible for instructing the UP function about how to detect user data traffic. For IPv4 or IPv6 or IPv4v6 PDU Session type, detection information provided to UPF may be a combination of: CN tunnel info, Network instance, QFI, IP Packet Filter Set and Application Identifier. The Application ID may be an index to a set of application detection rules configured in UPF.

The Rel-16 5G System may provide APIs that allow 3rd party service providers to deliver extended configuration for service data flow detection. This information may be provided as one or more application detection rules in Packet Flow Descriptions (PFDs) via the NEF. The one or more rules enable the detection of application traffic via IP filters or with other granularities, e.g., via URLs that need to be matched (or domain names, or protocol, as detailed in 3GPP TS 29.551, clause 5.6.2.5).

3GPP specification 23.501 defines several 5G QoS Parameters as part of QoS Implementation, including:

5G QoS Identifier (5QI): a scalar that may be used as a reference to 5G QoS characteristics, i.e., access node-specific parameters that control QoS forwarding treatment for the QoS Flow (e.g., scheduling weights, admission thresholds, queue management thresholds, link layer protocol configuration, and the like). Standardized 5QI values may have one-to-one mapping to a standardized combination of 5G QoS characteristics. The 5G QoS characteristics for pre-configured 5QI values may be pre-configured in the Access Node (gNB). Standardized or pre-configured 5G QoS characteristics may be indicated through the 5QI value, and may not be signaled on any interface, unless certain 5G QoS characteristics are modified. The 5G QoS characteristics for QoS Flows with dynamically assigned 5QI may be signaled as part of the QoS profile.

Allocation and Retention Priority (ARP): may comprise information about the priority level, the pre-emption capability, and the pre-emption vulnerability. The ARP priority level may define the relative importance of a resource request to allow in determining whether a new QoS Flow may be accepted or may need to be rejected in the case of resource limitations (may be used for admission control of GBR traffic). The ARP priority level may also be used to determine which existing QoS Flow to pre-empt during resource limitations. ARP may have one or more of the following characteristics: The range of the ARP priority level may be 1 to 15 with 1 as the highest level of priority. The ARP priority levels 1-8 may only be assigned to resources for services that are authorized to receive prioritized treatment within an operator domain (i.e., that are authorized by the serving network). The ARP priority levels 9-15 may be assigned to resources that are authorized by the home network and thus applicable when a UE is roaming. The ARP pre-emption capability may define whether a service data flow may receive resources already assigned to another service data flow with a lower ARP priority level. The ARP pre-emption vulnerability may define whether a service data flow may lose the resources assigned to it to admit a service data flow with higher ARP priority level. The ARP pre-emption vulnerability of the QoS Flow which the default QoS rule is associated with may be set appropriately to minimize the risk of unnecessary release of this QoS Flow.

Reflective QoS Attribute (RQA): an optional parameter which may indicate that certain traffic (not necessarily all) carried on this QoS Flow may be subject to Reflective QoS. When the RQA is signaled for a QoS Flow, the RAN/AN may enable the transfer of the RQI for AN resource corresponding to this QoS Flow. The RQA may be signaled to NG-RAN via the N2 reference point at UE context establishment in NG-RAN and at QoS Flow establishment or modification.

Notification Control: The QoS Parameter Notification control may indicate whether notifications are requested from the NG-RAN when the GFBR may no longer (or may again) be guaranteed for a QoS Flow during the lifetime of the QoS Flow. Notification control may be used for a GBR QoS Flow if the application traffic is able to adapt to the change in the QoS (e.g., if the AF is capable to trigger rate adaptation).

Flow Bit Rates: (for GBR QoS Flows, applicable for Uplink and Downlink). Guaranteed Flow Bit Rate (GFBR) denotes the bit rate that is guaranteed to be provided by the network to the QoS Flow over the Averaging Time Window. Maximum Flow Bit Rate (MFBR) limits the bit rate to the highest bit rate that is expected by the QoS Flow. Bit rates above the GFBR value and up to the MFBR value may be provided with relative priority determined by the Priority Level of the QoS Flows. GFBR and MFBR may be signaled to the (R)AN in the QoS Profile and signaled to the UE as QoS Flow level QoS parameter for each individual QoS Flow.

Per Session Aggregate Maximum Bit Rate (Session-AMBR, per PDU Session). The subscribed Session-AMBR may be a subscription parameter which may be retrieved by the SMF from UDM. SMF may use the subscribed Session-AMBR or modify it based on local policy or use the authorized Session-AMBR received from PCF to determine the Session-AMBR, which may be signaled to the appropriate UPF entity, to the UE, and to the (R)AN (to enable the calculation of the UE-AMBR). The Session-AMBR may limit the aggregate bit rate expected to be provided across all Non-GBR QoS Flows for a specific PDU Session. The Session-AMBR may be measured over an AMBR averaging window which may be a standardized value. The Session-AMBR may not be applicable to GBR QoS Flows.

Per UE Aggregate Maximum Bit Rate (UE-AMBR, per UE). The UE-AMBR may limit the aggregate bit rate that may be expected to be provided across all Non-GBR QoS Flows of a UE. Each (R)AN may set its UE-AMBR to the sum of the Session-AMBR of all PDU Sessions with active user plane to this (R)AN up to the value of the subscribed UE-AMBR. The subscribed UE-AMBR may be a subscription parameter which may be retrieved from UDM and provided to the (R)AN by the AMF. The UE-AMBR may be measured over an AMBR averaging window which may be a standardized value. The UE-AMBR may not be applicable to GBR QoS Flows.

Default QoS-related values. For each PDU Session Setup, the SMF may retrieve the subscribed default values for the 5QI and the ARP priority level and optionally, the 5QI Priority Level, from the UDM. The subscribed default 5QI value may be a Non-GBR 5QI from the standardized value range.

The SMF may change the subscribed values for the default 5QI and the ARP priority level and if received, the 5QI Priority Level, based on local configuration or interaction with the PCF to set QoS parameters for the QoS Flow which the default QoS rule may be associated with.

The SMF may set the ARP pre-emption capability and the ARP pre-emption vulnerability of the QoS Flow which the default QoS rule may be associated with based on local configuration or interaction with the PCF.

The SMF may apply the same values for the ARP priority level, the ARP pre-emption capability, and/or the ARP pre-emption vulnerability for any and/or all QoS Flows of the PDU Session unless a different ARP setting is required for a QoS Flow.

If dynamic PCC is not deployed, the SMF may have a DNN based configuration to enable the establishment of a GBR QoS Flow as the QoS Flow that is associated with the default QoS rule. This configuration comprises a standardized GBR 5QI as well as GFBR and MFBR for UL and DL.

Maximum Packet Loss Rate (UL, DL): may indicate the maximum rate for lost packets of the QoS flow that may be tolerated in the uplink and downlink direction. This may be provided to the QoS flow if compliant to the GFBR.

Based on 3GPP 23.501 clause 5.7.1.7, the following applies for processing of UL traffic: UE may use the stored QoS rules to determine mapping between UL User Plane traffic and QoS Flows. UE may mark the UL PDU with the QFI of the QoS rule comprising the matching Packet Filter and transmit the UL PDUs using the corresponding access specific resource for the QoS Flow based on the mapping provided by (R)AN. (R)AN may transmit the PDUs over N3 tunnel towards UPF. When passing an UL packet from (R)AN to CN, the (R)AN may provide the QFI value in the encapsulation header of the UL PDU and select the N3 tunnel. (R)AN may perform transport level packet marking in the UL on a per QoS Flow basis with a transport level packet marking value that may be determined based on the 5QI, the Priority Level (if explicitly signaled), and/or the ARP priority level of the associated QoS Flow. UPF may verify whether QFIs in the UL PDUs are aligned with the QoS Rules provided to the UE or implicitly derived by the UE in the case of Reflective QoS). UPF and UE perform Session-AMBR enforcement and the UPF may perform counting of packets for charging.

Based on 3GPP 23.501 clause 5.7.1.4, the UE may perform the classification and marking of UL User plane traffic, i.e., the association of UL traffic to QoS Flows, based on QoS rules. These QoS rules may be explicitly provided to the UE (i.e., explicitly signaled QoS rules using the PDU Session Establishment/Modification procedure), pre-configured in the UE or implicitly derived by the UE by applying Reflective QoS (see clause 5.7.5). A QoS rule comprises one or more of the QFI of the associated QoS Flow, a Packet Filter Set (see clause 5.7.6) and a precedence value (see clause 5.7.1.9). An explicitly signaled QoS rule comprises a QoS rule identifier which may be unique within the PDU Session and may be generated by SMF.

There may be more than one QoS rule associated with the same QoS Flow (i.e., with the same QFI).

The UE may inform the network about the number of supported Packet Filters for signaled QoS rules for the PDU Session. The SMF may ensure that the sum of the Packet Filters used by all signaled QoS rules for a PDU Session does not exceed a number indicated by the UE.

A default QoS rule may be required to be sent to the UE for every PDU Session establishment and may be associated with a QoS Flow. For IP type PDU Session or Ethernet type PDU Session, the default QoS rule may be the only QoS rule of a PDU Session which may comprise a Packet Filter Set that allows all UL packets, and in this case, the highest precedence value may be used for the QoS rule.

As long as the default QoS rule does not comprise a Packet Filter Set or comprises a Packet Filter Set that allows all UL packets, Reflective QoS may not be applied for the QoS Flow which the default QoS rule may be associated with and the RQA may not be sent for this QoS Flow.

The QoS rules information element may indicate a set of QoS rules to be used by the UE, where each QoS rule may be one or more of a set of parameters including (a) parameters for classification and marking of uplink user traffic; and (b) parameters for identification of a QoS flow which the network may use for a particular downlink user traffic.

The QoS rules may comprise one or more packet filters comprising zero or more packet filters for UL direction, zero or more packet filters for DL direction, zero or more packet filters for both UL and DL directions or any combinations of these. The one or more packet filters may determine the traffic mapping to QoS flows.

The QoS rules information element may be coded as shown in tables 1 and 2 from 3GPP TS 24.501.

Where traffic may be initiated in the DL and application of the QoS rules may be based on URL matching, the UPF may apply QoS marking to the DL traffic and the UE may be configured for Reflective QoS so that the same QoS treatment may be applied in the UL.

IP Packet Filter Set for a PDU Session of type IP supports any combination of: Source/destination IP address or IPv6 prefix; Source/destination port number; Protocol ID of the protocol above IP/Next header type; Type of Service (TOS) (IPv4)/Traffic class (IPv6) and Mask; Flow Label (IPv6); Security parameter index; Packet Filter direction.

Another QoS treatment method at the UE may involve the use of reflective QoS. Reflective QoS may be controlled on the network side on a per-packet basis, comprising a Reflective QoS Indication (RQI) together with a Reflective QoS Timer (RQ Timer) value that may either be signaled to the UE upon PDU Session Establishment (or upon PDU Session Modification) or set to a default value. The RQ Timer value provided by the core network may be at the granularity of PDU session.

Upon reception of a DL packet with RQI, if a UE derived QoS rule with a Packet Filter corresponding to the DL packet does not already exist, the UE may create a new UE derived QoS rule with a Packet Filter corresponding to the DL packet. The UE may also start a timer set to the RQ Timer value for the UE derived QoS rule and may update the QFI of the UL packet with the QFI based on the derived rule.

TABLE 1
QoS rule

| | | | | | | | |
|---|---|---|---|---|---|---|---|
| 8 | 7 | 6 | 5 | 4 | 3 | 2 | 1 |

| QoS rule identifier | | | octet 4 |
|---|---|---|---|
| Length of QoS rule | | | octet 5 |
| | | | octet 6 |
| Rule operation | DQR | Number of packet | octet 7 |
| code | bit | filters | |

| Packet filter list | | | octet 8* |
|---|---|---|---|
| | | | octet m* |
| QoS rule precedence | | | octet m + 1* |
| 0 | Segregation | QoS flow identifier (QFI) | octet m + 2* |
| Spare | | | |

TABLE 2
Packet filter list example in a QoS rule

| | | | | | | | |
|---|---|---|---|---|---|---|---|
| 8 | 7 | 6 | 5 | 4 | 3 | 2 | 1 |

| | | | | |
|---|---|---|---|---|
| 0 | 0 | Packet | Packet filter identifier 1 | octet 8 |

| | |
|---|---|
| Spare | filter |
| | direction 1 |

| Length of packet filter contents 1 | | | | octet 9 |
|---|---|---|---|---|
| Packet filter contents 1 | | | | octet 10 |
| | | | | octet m |
| 0 | 0 | Packet | Packet filter identifier 2 | octet m + 1 |

| | |
|---|---|
| Spare | filter |
| | direction 2 |

| Length of packet filter contents 2 | | | | octet m + 2 |
|---|---|---|---|---|
| Packet filter contents 2 | | | | octet m + 3 |
| | | | | octet n |
| . . . | | | | octet n + 1 |
| | | | | octet y |
| 0 | 0 | Packet | Packet filter identifier N | octet y + 1 |

| | |
|---|---|
| Spare | filter |
| | direction N |

| | |
|---|---|
| Length of packet filter contents N | octet y + 2 |
| Packet filter contents N | octet y + 3 |
| | octet z |

The concept of QoS Profile encompasses the QoS parameters sent to RAN for each QoS flow and is defined in 3GPP 23.501 clause 5.7.1.2.

For each QoS Flow, the mandatory QoS parameters in the QoS profile are (a) 5G QoS Identifier (5QI); and (b) Allocation and Retention Priority (ARP).

For each Non-GBR QoS Flow only, the QoS profile optionally comprises Reflective QoS Attribute (RQA).

For each GBR QoS Flow, the QoS profile may provide Guaranteed Flow Bit Rate (GFBR)—UL and DL; Maximum Flow Bit Rate (MFBR)—UL and DL; Notification control; Maximum Packet Loss Rate—UL and DL.

The QoS Profile may be provided to RAN via the N2 interface by AMF in the PDU Session Resource Setup Request Transfer and PDU Session Resource Modify Request Transfer, as well as handover requests. The QoS Profile may be provided as a list of “QoS Flow Setup Request Item(s)”. Each list item in turn comprises mandatory QFI and QoS Flow Level QoS Parameters.

For the PDU Session Resource Setup Request, for each requested PDU session, if resources are available for the requested configuration, the NG-RAN node may establish at least one DRB and associate each accepted QoS flow of the PDU session to a DRB established.

Based on the PDU Session Resource Modify Request Transfer, for each PDU session requested (to be added or modified), the NG-RAN node may modify the DRB configuration and may associate the QoS flows indicated to be setup or modified with the DRB.

Based on 3GPP TS 29.512 clause 4.2.6.2.3, the PCF may provide the authorized QoS for a PCC rule to the SMF using the PCC rule provisioning procedure. The authorized QoS may be provided for a PCC rule. The SMF may derive the QoS profile towards the access network, the QoS rule towards the UE, and the QoS information with the PDR(s) towards the UPF.

Based on 3GPP TS 23.501 clause 5.8.2.7, for every QoS Flow, the SMF may determine the transport level packet marking value (e.g., the DSCP in the outer IP header) based on the 5QI, the Priority Level (if explicitly signaled), and, optionally, the ARP priority level and may provide the transport level packet marking value to the UPF.

The SMF may provide the Session-AMBR values of the PDU Session to the UPF so that the UPF may enforce the Session-AMBR of the PDU Session across all Non-GBR QoS Flows of the PDU Session. SMF may provide the GFBR and MFBR value for each GBR QoS Flow of the PDU Session to the UPF. SMF may also provide the Averaging window to the UPF.

The 3GPP SA1 Working Group describes requirements for Tactile and multi-modality (communications) in TR 22.827. The following requirements are especially relevant for coordinated communications: 1) [PR 5.1.6-2] The 5G system may enable means to meet a synchronization threshold for flows of multiple UEs associated with an application based on input received from an authorized 3rd party, 2) [PR 5.3.6-2] The 5G system may support a mechanism to allow an authorized 3rd party to provide QoS policy for coordination between flows of multiple UEs associated with an application. The policy may comprise e.g., the set of UEs and data flows, the expected 5GS QoS handling(s) and associated triggering events, expected coordination assistance provided by 5G system between the multiple flows for different traffic types (e.g., haptic, audio and video), 3) [PR. 5.5.6-1] The 5G network may support a mechanism to allow an authorized 3rd party to provide QoS policy for flows of multiple UEs associated with an application. The policy may comprise e.g., the expected 5GS handling and the associated triggering event, 4) [PR. 5.5.6-2] The 5G system may support a mechanism to apply QoS policy for flows of multiple UEs associated with an application received from an authorized 3rd party, and 5) [PR 5.7.6-3] The 5G system may support a mechanism to assist the synchronization between the multiple streams (e.g., haptic, audio and video) of a multi-modal communication session, which may avoid the negative impact on the user experience.

There may be issues associated with live event selective immersion. To provide immersive experience of a live football game to an audience not at the scene of the live football game, multiple AI cameras may be deployed in a stadium collecting video and audio data from different vantage points for generation of footage at an Application Server (AS). Various footage streams may be provided to the audience for selection.

AI cameras may predictively follow the live action, using one or more specific objects to follow e.g., the ball or a player. The Application Server may predict the potential actions of the one or more objects based on data collected from the prediction cameras. The footage camera viewports may be instructed how to follow.

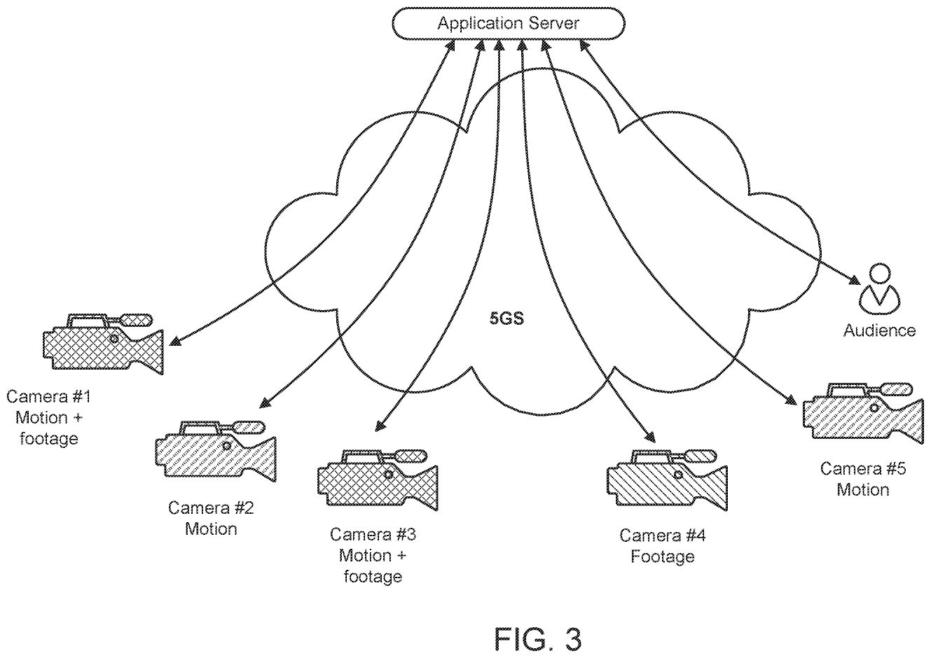

In FIG. 3, the UEs in Cameras #1 through #5 may be switched on and registered to the 5G system. The Application Server may inform 5GS that the UEs are subject to the service application and may provide QoS requirements of the UEs and the coordination policies for the multi-modality service for assistance from 5GS.

In one example, the Application Server may make motion prediction based on data received from prediction Camera #1, Camera #2, Camera #3, and Camera #5, and may generate footage based on data received from the viewports of Camera #1, Camera #3, and Camera #4. In addition to motion prediction data exchanged with the camera, the AS may transmit footage over 5GS to the audience UEs.

Based at least in part on the coordination policy of the multi-modality service, if the target QoS of Camera #1 cannot be guaranteed because, for example, network congestion, 5GS may reduce the QoS of Camera #4 to make sure the QoS of Camera #1 is guaranteed; if the network congestion is relieved, 5GS may increase the QoS of Camera #4 while the target QoS of Camera #1 is still guaranteed.

In case of further network congestion, the target QoS of Camera #2 may also no longer be guaranteed. In one example, the motion data collected by Camera #2 is mandatory for motion prediction, and the 5GS may release resources of Camera #2 and Camera #5 based on the coordination policy of the multi-modality service. In this example, the coordination policy may require the 5GS network to only guarantee QoS of Camera #1 or to release resources of all the cameras.

There may be issues associated with monitoring data flow in a factory. The factory may comprise 5G coverage, further comprising an industrial robot and a monitoring camera connected via a 5G virtual network (VN).

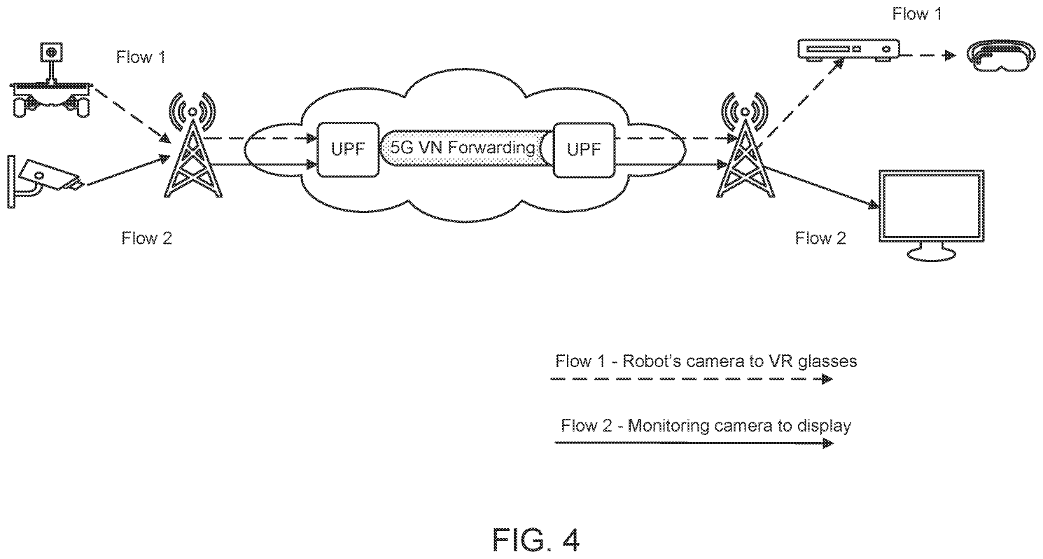

In FIG. 4, the factory application provider may use a 5G virtual network understanding that the application it provides comprises data flows needing low delays and coordination. In this case, the requirements apply to at least a robotic motion information collection flow and a monitoring video flow.

The motion information of the robot may be collected by the robot's camera, transferred through data flow 1 and to a VR, producing VR output.

A monitoring camera may capture real-time movement of the factory floor comprising the industrial robot and may transmit the video through data flow 2 to a display.

In one example, at a remote site, a virtual factory may be created and displayed using multiple modalities, i.e., VR rendering and video monitors. The application provider may configure the VN for traffic forwarding in order to meet the low delay requirements.

As the motion processing at the VR server needs time, data flow 2 may be delayed by the network for a first period of time. The delay may be necessary so that the VR and monitor video data flows arrive at the remote site within a specified time window and minimizing a delay between the two data flows arriving.

Multi-modal applications such as TACMM may introduce new relationships between the resources allocated in the system to multiple specified data flows in different UEs. The resources required in such cases may be directly or inversely correlated from a QoS perspective, may require service-level synchronization where synchronization or other types of coordination of data streams may take place in the 3GPP systems (e.g., core network, access network including 3GPP radio access technology-based access network, or in the UE or across UEs) to meet the requirements of a single service.

In legacy 3GPP systems, for example LTE or 5G systems, there is no support of coordination or synchronization of the processing, the delivery or transmission timing, or the data forwarding treatment of data streams across different UEs or within the context of a single UE. Furthermore, even in UMTS system where some level of coordination of data streams within an application data unit or within a PDU (Protocol Data Unit) may be supported, the support may be limited to the context of one UE and not across multiple UEs. Therefore, System enhancements are needed to support the coordination and/or synchronization of data forwarding treatment, including the scheduling, processing, delivery, and/or transmission timing of data streams across different UEs and/or within the context of a single UE. System enhancements are needed to account for the use cases where coordination of multiple UEs in how they consume the resources of the 5G system may be required.

The fact that the 5G System does not currently provide means for data flows of one or more UEs to be associated in coordinated communication groups managed by AFs via the network is an issue in need of a solution. To enable the required coordination for multi-modal services, processes to allow one or more UEs and the network to be able to determine which data flows (belonging to one or more UEs) are part of a coordinated communication group may also be required.

For the UL, it may be inefficient for the 5GC to frequently send coordination information for the UE to act on. Instead, the UE may be enabled to detect when coordination is desirable and what actions are needed to provide the coordination functionality. Similarly, the UEs, ideally, may be enabled to provide assistance for service-level flow synchronization.

Several system enhancements are proposed so that data flows from multiple UEs may be coordinated in consuming the resources of the 5G system. System enhancements enabling UEs to assist with service-level synchronization for multi-modal services are also proposed. At least the following aspects are detailed herein: 1) Methods enabling data flows of multiple UEs to be associated in coordinated communication groups managed by Application Servers via the network, 2) Methods enabling UEs and the network to determine what UEs and which data flows are part of a coordinated communication group, 3) Methods enabling UEs to be provided with communication coordination rules and policies, 4) Methods enabling the UEs to evaluate triggers for the communication coordination rules and to apply the required coordination actions, and 5) Methods enabling the UEs to provide assistance for service-level flow synchronization for multi-modal services.

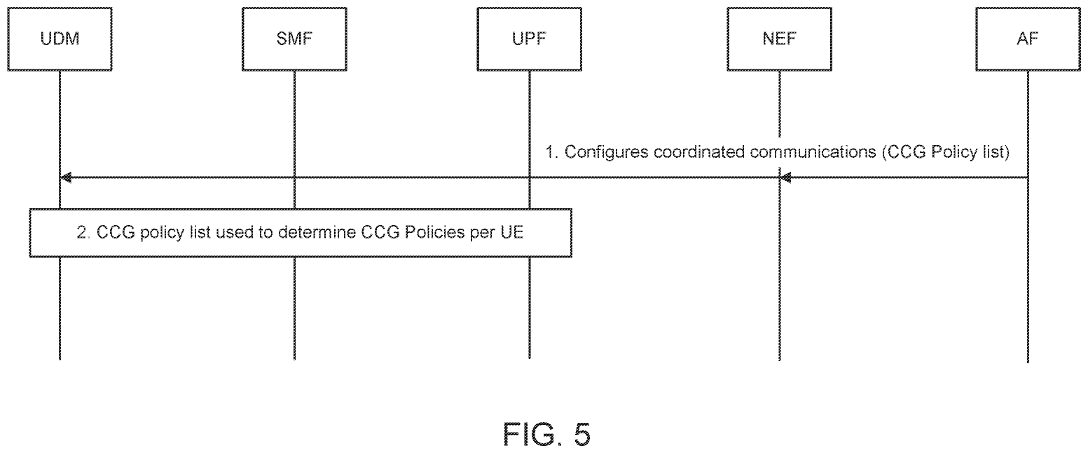

Coordinated Communication Groups (CCG) may be created in the 5GS on request from Application Functions or application Servers (AF/AS). Such requests may be provided via the NEF and may comprise information as detailed in Table 1. FIG. 5 describes a procedure for CCG configuration based on an AF request.

In FIG. 5, at step 1, an AF makes a request for coordinated communications. The request may provide a CCG ID, a list of UE identifiers (e.g., GPSI) and one or more data flows, the desired QoS treatment for each UE, or the like, as described in Table 4 below. The AF may send the request to an NEF, which may forward the request to a UDM to configure the Coordinated Communication Group. The NEF may translate the public UE identifiers (i.e., GPSIs) received from the AF into internal network identifiers (i.e., SUPIs). The configuration information may comprise a DNN and S-NSSAI.

In FIG. 5, at step 2, the CCG Policy list may be provided by the AF, describing the communication coordination behavior required for the group, may be used to create per-UE CCG rules for the group member UEs. The per-UE CCG rules may be stored at the UDM and may be available at various CN nodes.

The CCG configuration may provide information required to so that the network may identify the CCG members (i.e., UEs and data flows). The configuration may also provide associated CCG Policies or information which may be used to derive CCG Policies that describe the functionality to be implemented to support the communication coordination.

TABLE 3
CCG configuration information

| Parameters | Description |
|---|---|
| External Group ID | An identifier for 5G CCG |
| DNN | DNN for the 5G CCG |
| S-NSSAI | S-NSSAI for the 5G CCG |
| PDU Session Type | PDU Session Types allowed for 5G CCG |
| CCG member list | List of CCG members, comprises the |
| | information detailed below |
| >GPSI | GPSI for each of the 5G CCG UE members |
| >UE address | The address (IP or Ethernet) of the UE |
| | members, if available |
| >Flow description(s) | Flow descriptions for each of the member data |
| | flows |
| Authentication/ | This information is used to authorize the |
| authorization | coordination information and may comprise |
| information | AAA server addressing information. |
| Provider information | Information about the provider of the |
| | information and of the service using the CCG |
| CCG Policy list | If the CCG Policies are explicitly provided by |
| | the AF, this information comprises the |
| | parameters in Table 4. Alternatively, |
| | information is provided to be used by PCF and |
| | other CN NFs to derive CCG policies. |

Note, an AF CCG configuration request may be implemented by extending existing NEF functionality, for example Parameter Provisioning API, AF traffic influence API, or AF session with QoS request API.

An AF CCG configuration request may be implemented by extending existing NEF functionality such as Parameter Provisioning API, AF traffic influence API or AF session with QoS request API.

It may be undesirable for the 5GC to frequently send updated CCG policies and/or rules to the LUE. Instead, the UE may detect when it needs to take action to facilitate coordination and determine what actions provide the coordination functionality.

The methods proposed rely upon the network providing information (i.e., via proposed CCG policies) to the UE so that the UE knows (i.e., may determine) when to change the behavior of the coordinated data flows. The policies and/or rules may be determined by the 5GC, by an AF/AS, or by the 5GC based on input from an AF/AS.

A CCG policy may comprise one or more CCG rules, where each CCG rule may comprise: 1) a CCG rule identifier; 2) an identifier of the CCG group to which the rule may apply; 3) one or more CCG member identifiers, identifying the UEs and data flows that may be affected by the rule; 4) a CCG rule trigger. The CCG rule trigger may indicate to the UE one or more conditions that need to be monitored for and/or detected by the UE in order to determine when to start, stop, or change the treatment of the coordinated data flow; 5) a coordination window, providing a timing reference point and time window, or time window granularity for coordination. For example, this may be used as a data buffering window for coordination; 6) a list of one or more coordination commands that describes actions that may need to be done to implement the communication coordination required by the CCG rule; and 7) a synchronization rule to be applied by the UE.

The description of the treatment that needs to be applied to coordinate the data flow is provided via coordination commands.

Examples of CCG rule triggers as described in step 4) above comprise: latency or data rate on a data flow reaching a threshold; UE location, projected path, speed or proximity to other UEs meets the provided criteria; RCM with specific value received; change of view Port for a data flow; one or more pre-emption or retention rules; the offset, for example a time stamp offset, between PDUs or application data units within a data flow or across data flows within a CCG reaching a threshold; a threshold value specifying the time window in which multi-modality inputs need to arrive at and that may be perceived as being synchronous, allowed maximum time stamp offset (which could be defined per pair of data flow or any subset of traffic flow within the CCG).

Other examples of triggers may be the determination of fulfillment or non-fulfillment of QoS requirements associated with the data flow. The determination of fulfillment or non-fulfillment of QoS may be done in a UE or at the network and communicated to the UE. If the determination of fulfillment or non-fulfilment of QoS is performed in the UE, the network may configure into the UE, one or more thresholds, wherein the one or more thresholds may be associated with one or more QoS profile parameters configured into the UE for a data flow. In yet in another example, a trigger may be a request from a user to add a view port or remove a view port (which for example may be due to the change in direction or viewing angle or position of the controlling UE or entity performing communication coordination or may be due to the change in direction or viewing angle or position of a controlled UE—for example a UE that is monitoring a specific action or scene and providing feedback to the controlling UE or entity.

CCG coordination commands and CCG Rule Triggers may be associated such that the UE is configured to apply one or more coordination commands when it detects a particular CCG rule Trigger.

Lists of coordination commands as described in step 6) above may describe actions which need to be taken by the UE in order to provide coordinated communications for the CCG group. Each list of coordination commands may describe the relationship to be maintained between data flows in order to provide communication coordination. Each coordination command may comprise: (i) one or more data flow identifiers, including associated view Port Identifiers; (ii) one or more data flow characteristics e.g., bit rate, latency, data flow type, and the corresponding packet filter set, for example IP type and the associated IP packet filter set, ethernet type and the associated ethernet packet filter set, unstructured type, one more data class within the data flow and the associated QoS flow for each data class, and the like; (iii) one or more coordination actions.

The data flow identifiers may be implemented as IP Packet Filters, non-IP Packet filters, and the like. For example, a Packet Filter Set for IP PDU Sessions may be used, including any combination of: Source/destination IP address or IPv6 prefix; Source/destination port number; Protocol ID of the protocol above IP/Next header type; Type of Service (TOS) (IPv4)/Traffic class (IPv6) and Mask; Flow Label (IPv6); Security parameter index; Packet Filter direction. Additional Packet Filter parameters may be provided, e.g., Application ID, view Port Identifiers. QFIs may be used to provide data flow identification in conjunction with other unique PSU session parameters.

The coordination actions may also comprise: (iv) timing reference point and time window or time window granularity for coordination, for example this may be used as data buffering window for coordination; (v) allowed maximum time stamp offset, which may be defined per pair of data flow or any subset of traffic flow within the CCG; such offset may be used to determined coordination between PDUs or application data units within a data flow or across data flows within a CCG; (vi) one or more triggers for data flow coordination initiation/activation, modification or stoppage/deactivation. For example the one or more triggers may comprise one or more pre-emption or retention rules which may dictate criteria to modify a CCG i.e. drop a CCG or activate a CCG, or criteria to drop/de-activate a data flow or criteria to add/activate a data flow in CCG; activating a data flow or deactivating a data flow could be interpreted or viewed as a mechanism to activate or de-activate a CCG; (vii) one or more view Port Identifiers i.e. an identifier of the view port associated with a data flow; (viii) CCG Synchronization Markers (CSM).

Examples of coordination actions comprise: assign a specific QFI value to an UL flow; find a QFI corresponding to a characteristic (e.g. data rate) and assign it to an UL flow, modify or stop an UL flow or PDU session, change current CCG rule to another; start or stop a measurement, pre-emption or retention of a data flow i.e. addition or activation of a data flow, or dropping or removal/termination of a data flow, adding CCG Synchronization Markers (CSM); adding RCM (Reflective Coordination Markers), and the like. A coordination action may be implemented as a QoS Rule which indicates to the UE what QFI markings may be applied to a data flow. A coordination action implemented as a QoS Rule indicates to the UE what flow characteristics (which may comprise a maximum bit rate or minimum required latency) to apply and the corresponding QFI marking.

The synchronization rule as described in step 7) above is further detailed. A synchronization rule may be implemented also as stand-alone rule or policies, independent of CCG policies. Synchronization rules may also be implemented as a specific type of CCG rule.

TABLE 4
CCG Policy

| Parameters | Description |
|---|---|
| CCG Rule List | List of CCG rules, each rule as described below |
| >CCG Rule ID | Unique CCG rule identifier |
| >External | Identifier of the CCG the rule applies to |
| Group ID | |
| >CCG member | Identifiers of the CCG UE and flow members |
| identifiers | involved in the rule |
| >CCG rule | One or more conditions monitored or detected by the |
| trigger(s) | UE in order to determine when to start, stop or |
| | change the corresponding coordination commands. |
| | Examples: latency or data rate on a flow reaching a |
| | threshold; UE location, projected path, speed or |
| | proximity to other UEs meets the provided criteria; |
| | RCM with specific value received; one or more pre- |
| | emption or retention rules which may dictate criteria |
| | to modify a CCG i.e. drop a CCG or activate a CCG, |
| | or criteria to drop/de-activate a data flow or criteria |
| | to add/activate a data flow in CCG; one or more view |
| | Port Identifiers i.e. an identifier of the view port |
| | associated with a data flow; received CCG |
| | Synchronization Markers (CSM); threshold for timing |
| | offset between PDUs or application data units within |
| | a data flow or across data flows within a CCG to be |
| | perceived as being coordinated. |
| >Coordination | Timing reference point and time window or time |
| window | window granularity for coordination, for example this |
| | could be used as data buffering window for |
| | coordination. |
| >List of | List of one or more coordination commands to be |
| coordination | applied by the UE at the same time e.g., by using |
| commands | logical operators such as AND, OR, NOT, XOR, or |
| | the like. |
| | Examples of coordination commands: apply specified |
| | QFIs to the CCG UL data flows (e.g., apply QoS |
| | Rule); discover QoS needed to apply a requirement |
| | and apply the corresponding QFIs to the CCG UL |
| | data flows; start, stop, or modify a CCG flow or PDU; |
| | change current CCG rule to another; start or stop a |
| | measurement; start or stop sending measurement |
| | reports, adding CSM; adding RCM, pre-emption, or |
| | retention of a data flow, a QoS rule |
| >Synchronization | Synchronization rules to be applied by the UE to |
| Rule | provide application-level synchronization assistance. |
| | See table 5. |

As shown in the Virtual Factory use case, communication coordination may comprise a desire for flow synchronization at the application level, which may be necessary for multi-modal services. While the application layer may handle certain aspects of the synchronization, the ability of the 5GS transport to assist synchronization is also desirable.

For example, the Virtual Factory use case may also comprise an immersive XR control scenario using UE-to-UE communications within a Virtual Network (VN) to minimize latencies between the users. The application layer at each UE preserves a functional service relationship of the application data flows between several media streams, but in some cases multiple applications on the same UE may be involved.

In addition, a UE may need to maintain service relationships between inputs from multiple UEs, from multiple servers (including cloud and edge servers) or combinations of the two.

Examples of the service relationships that may be preserved by the application-level synchronization comprise: aligning video data flows used by separate applications (as introduced by the Virtual Factory use case), aligning haptic feedback (e.g., feeling a hit) with video (e.g., seeing an incoming object) when using different UEs for each modality, and the like.

Service configuration information used in such communication coordination/synchronization may be provided at the application layer to a Service Manager (SM) server which defines the characteristics and requirements of the service. The service-level requirements may be provided by AFs and disseminated to all necessary nodes.

To enable application-level synchronization at the receiving server or peer application, the application layer on the UE may add CCG Synchronization Markers (CSM) at specific packets to be synchronized. CSMs may also be available to the UE modems so that the 5G network may be used to assist the synchronization. The UE may report CSM to the 5G network for example the RAN or the core network which the 5G network (core network or RAN) may use to assist the synchronization or to perform the synchronization. Alternatively, the CSM may be reported by the application server or the application network to the 5G network (core network or RAN). The 5G network (core network or RAN) may be configured by one or more UEs with the CSM to facilitate one or more multi-modality communication control action for e.g., synchronization of data flows or data packets across data flows, pre-emption or retention of data flows, or adjustment in data forwarding treatment for example application of unequal error protection.

The synchronization rules in a CCG Policy may comprise: (i) CSM detection characteristics.; (ii) a list of one or more application-level synchronization measurements (iii) a list of one or more synchronization actions.

The CSM detection characteristics may provide information for the UE modem to be able to detect CSM in the received or transmitted data flows. For example, the CSM may be based on a specified bit string and/or comprise sequence number, time information, periodicity, and the like. The algorithm for determining CSM may be predetermined or indicated in the rule. This CSM information may be associated with one or more of the CCG flows to be synchronized.

The list of application-level synchronization measurements specified in the synchronization rule may comprise the following: (a) For the DL, the UE modem may detect CSM and may calculate CSM DL Rx-delta measurements of the receiving time difference between corresponding CSM on different CCG data flows. (b) For the UL, the UE modem may detect CSM and may calculate CSM UL arrival-delta measurements of the arrival time difference between corresponding CSM on different CCG data flows. In cases in which there is a single UE application or a UE synchronization unit assisting multiple applications, the measurement may be zero. However, in cases in which separate UE applications provide the coordinated data flows and no synchronization unit assistance is available, the CSM UL arrival-delta measurement may provide information about the level of synchronization between the applications. Also, for the UL the modem may calculate CSM UL TX-delta measurement as the time difference between CSM transmissions for coordinated data flows. In addition to possible lack of application-level synchronization in UL arrival from the corresponding applications, the CSM UL TX-delta measurement may account for re-transmissions. To account for re-transmissions, the measurement may be provided only after all acknowledgements (e.g., including layer 1, IP-level, and/or application-level acknowledgements) are received. (c) CSM with round trip time measurements to obtain both UL and DL latency. This may be implemented using specific CSMs generated by the UE, with the UPF, AF, or counterpart UE adding corresponding CSMs or CSM add-on markings in the response.

TABLE 5
CCG Synchronization Rule

| Parameters | Description |
|---|---|
| CSM detection | Characteristics used to detect CSM in the |
| characteristics | received or transmitted data flows. |
| | Examples: a specified bit strings; sequence |
| | number; time stamp' time and periodicity |
| | information; an algorithm. |
| Synchronization threshold | A threshold value specifying the time |
| | window in which multi-modality inputs need |
| | to arrive at and that may be perceived as |
| | being synchronous |
| List of application-level | Measurements to be used to implement the |
| synchronization | rule. |
| measurements | Examples: CSM DL RX-delta; CSM UL |
| | arrival-delta; CSM UL TX-delta. |
| List of synchronization | List of one or more synchronization actions |
| actions | to be applied by the UE based on the rule |
| | trigger. Actions comprise: providing |
| | application-level synchronization or other |
| | measurement reports; providing UL delay |
| | and/or buffering for the purpose of |
| | application-level flow synchronization. |

The list of application-level synchronization measurements specified in the synchronization rule may comprise the following: (a) For the DL, the UE modem may detect CSM and may calculate CSM DL Rx-delta measurements of the receiving time difference between corresponding CSM on different CCG data flows. (b) For the UL, the UE modem may detect CSM and may calculate CSM UL arrival-delta measurements of the arrival time difference between corresponding CSM on different.

The list of synchronization actions specified in the synchronization rule may comprise: (a) providing application-level synchronization or other measurement reports (b) providing UL delay and/or buffering for the purpose of flow synchronization.

The reports requested via the synchronization rule may comprise reports of these measurements to the RAN, UPF, CN, AF, its own UE applications, or peer UEs in the VN (when the data flows comprise direct communications between VN UEs).

The UL buffering or delays requested via the synchronization rule may be specified relative to desired CSM UL TX-delta measurement or by providing other timing performance indicators to be achieved.

Note that the conditions to be met to apply the synchronization actions specified in the synchronization rule may be provided as a CCG rule trigger if the synchronization policy is associated with a CCG rule. Specific synchronization rule triggers may be specified. As mentioned earlier, the synchronization rules may also be implemented as a specific type of CCG rules.

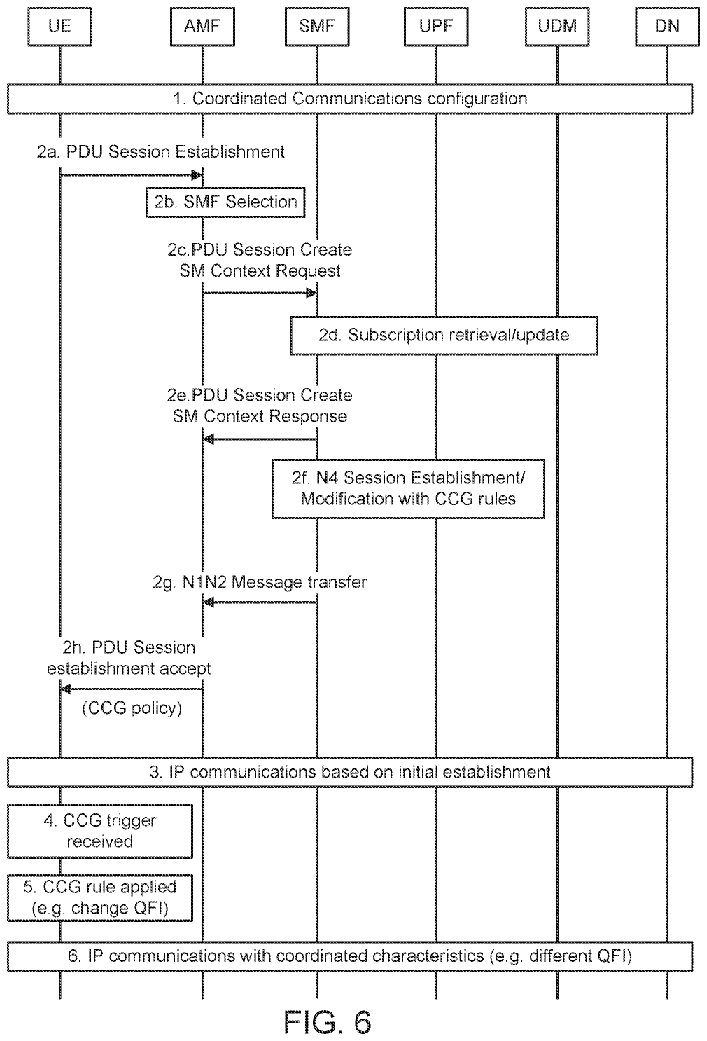

In FIG. 6, step 1 describes performance of the Coordinated Communication configuration procedure by the AF. The CCG Policy list provided by the AF (and detailed in table 4), describing the communication coordination behavior that may be used for the group, may be used to create per-UE CCG rules for the group member UEs.

Note: For simplicity, the upcoming text uses the term “CCG rule” to substitute for “per-UE CCG rules”. Per-UE CCG rules are the rules sent to the UE. Per-UE CCG rule parameters may be the same with those in the CCG Policy (i.e., Table 4) or may be determined/derived from the CCG Policy list rules described in table 4 (which are termed CCG Rules). For example, the UE IDs of the other UE members of the group, which may be in the CCG rules provided by the AF, do not need to be sent to the UE. Similarly, the coordination actions to be taken by an individual UE may be based on, but different from, the coordination actions described by the AF for the entire group. The AF may provide per-UE rules and the derivation of per-UE CCG rules from the group CCG Policy, though they may be minimal.

In FIG. 6, step 2 describes that a PDU Session Establishment message may be sent by the UE. The PDU Session Establishment Request may comprise the CCG ID, if provisioned to the UE over the application layer. Alternatively, the CCG ID may be determined by the UE during URSP evaluation. For example, a CCG ID may be part of a Route Selection Descriptor and the UE may provide the CCG ID from the RSD to the network during PDU Session Establishment. The PDU Session Establishment Request may comprise a DNN and S-NSSAI. The DNN and S-NSSAI may be provisioned to the UE over the application layer, pre-configured in the UE or determined during URSP evaluation.

The SMF may execute the PDU Session establishment procedure from section 4.3.2.2.1 of TS 23.502. The SMF may provide the CCG ID, DNN, and S-NSSAI to the PCF and check if coordinated communications are allowed for these PDU sessions. Steps 2d, 2f and 2h show how the SMF may obtain and return a (per-UE) CCG Rule to the UE in the PDU Session Establishment Response message. The contents of the per-UE CCG Rule may be the same as those in Table 4 or be derived based on the parameters in Table 4.

Step 3 describes that the UE may generate traffic on the newly established PDU session, using the provided (per-UE) CCG Rule.

Step 4 describes that a CCG trigger corresponding to a received CCG Rule may occur. For example, the latency or data rate on a flow reach a threshold; UE location, projected path, speed, or proximity to other UEs meets the provided criteria; RCM with a specific value may be received. Examples of CCG Triggers are further listed in Table 4.

In step 5, the UE may apply the coordination actions, e.g., may adjust QoS parameters and QFI for flow 2 and flow 3. Examples of coordination actions are further listed in Table 4 and described below.

In step 6, the IP communications may proceed with the coordinated characteristics.

For example, the method described in FIG. 6 may comprise receiving, by a NAS layer of a WTRU, a coordination identifier from an application associated with the WTRU, wherein the application receives the coordination identifier from an application server. The method may further comprise sending, by the WTRU and to a core network entity, a request to establish a PDU session, wherein the request comprises the coordination identifier indicating that one or more rules associated with the PDU session are to be coordinated with one or more rules associated with other PDU sessions between the core network and other WTRUs. The method may further comprise receiving, by the WTRU, configuration information associated with the PDU session, wherein the configuration information comprises the one or more rules that are to be coordinated with the one or more rules associated with the other PDU sessions; and receiving, by the WTRU, from the core network entity, a message indicating establishment of the PDU session.

The method described in FIG. 6 may further comprise determining, by the WTRU, the coordination identifier using a user route selection policy (URSP) rule.

At least one of the one or more rules associated with the PDU session described in FIG. 6 may comprise an action and an indication of a trigger condition to be used by the WTRU to determine when to perform the action on a coordinated data flow.

The trigger condition described in FIG. 6 may comprise one or more of: a latency threshold, an indication of a location of the WTRU, a speed of the WTRU, or a proximity of the WTRU to other WTRUs.

The action described in FIG. 6 may comprise one or more of: changing QoS markings associated with the coordinated data flow, applying a delay to the coordinated data flow, performing a measurement on the coordinated data flow, or buffering the coordinated data flow.

The core network entity described in FIG. 6 may comprise an SMF.

The method described in FIG. 6 may further comprise performing, based on detecting the indication of the trigger condition, the action on the coordinated data flow.

The method described in FIG. 6 may further comprise sending, based on the action and via the PDU session, a message to the core network entity.

The method described in FIG. 6 may be implemented by an apparatus. For example, the apparatus may be a WTRU.

The following paragraphs provide several examples of CCG policies and the UE behavior implementing functionality for the coordination of communication resources, e.g., QoS. The examples may comprise CCG triggers and UE behavior based on the list of coordination commands. The examples do not represent an exhaustive list of possible implementations of the CCG rules provided to the UE. In addition, the examples are provided with the assumption that additional functionality may be derived using composite policies aggregating aspects from multiple of the examples.

One example describes UL flow QFIs coordinated based on other flow characteristics. In the present example, the CCG trigger may be based on characteristics of one or more data flows from the set provided in the CCG. For example, the Trigger may describe one or more DL flows and the UE may consider the trigger condition to be met when data is received that matches the description of the one or more DL data flows. The description of the DL flow may describe the flow with a combination of port number, IP address, transport protocol, or application layer protocol. In the present example, the list of coordination commands to be applied by the UE involves QFI changes for one or more UL flows from the set provided in the CCG. The UE may change what QFI it applies to an UL data flow based on detecting that the trigger condition is met.

The present example may apply to a scenario where one UE uses data from a DL data flow to provide haptic feedback to the user and multiple UL flows to independently send video, audio, ambient and haptic data collected through sensors on the same apparatus. The aim may be to coordinate the quality of the UL data flows based on the DL data flow.

The CCG rule provided to the UE may be used to implement functionality such as: 1) when latency on a specified CCG data flow becomes greater than a specified value, each of the QFIs of the CCG UL data flows may be changed to reflect QoS with the latency of the DL; 2) when data rate on a specified CCG data flow reaches a specified value, each of the QFIs of the CCG UL data flows may be changed to reflect proportional data rate changes; and 3) based on determining that the DL flow data rate on a specified CCG data flow is below a functional threshold (so haptic feedback is no longer possible), one UL flow (for haptic input) is stopped and the current CCG rule may be exchanged for another specified CCG rule, using triggers based on a different DL data flow. The above is not an exhaustive list, as other triggers based on DL data flow characteristics used to coordinate UL data flow QFIs may be envisioned.

The trigger may also describe one more data flow characteristics of an UL flow (termed trigger UL data flow) and the UE may consider the trigger condition to be met when transmitted data matches the description of the one or more UL data flows. The UL flow characteristics and the list of coordination commands to be applied by the UE may be similar to the DL case described previously.

The CCG rule provided to the UE in this case may be used to implement functionality such as: 1) based on determining the trigger UL data flow starts or stops, each of the QFIs of the other CCG UL data flows may be set to a specific value; 2) based on determining that the data rate on the trigger UL data flow has reached a specified value, one or more of the QFIs of the CCG UL data flows may be changed to reflect proportional data rate changes; and 3) based on determining that the trigger UL flow data rate is below a functional threshold (so haptic feedback is no longer possible) the current CCG rule is exchanged for another specified CCG rule, which uses triggers based on a different UL data flow.

Another example may describe UL flow QFIs coordinated based on other flow characteristics. The CCG trigger may be based on UE geo-spatial characteristics such as location, projected path, speed, proximity to other apparatuses, and the like. For example, the Trigger may describe geo-spatial characteristics conditions to be met by the UE. In this example, the list of coordination commands to be applied by the UE may involve QFI changes for one or more UL data flows from the set provided in the CCG. The UE may change what QFI it applies to an UL flow based on determining that the trigger condition is met (i.e., when the UE matches the geo-spatial characteristics).

The present example may apply to a virtual factory scenario where a Multi-Modality service employs different quality of service in different areas. A robotic UE may provide captured footage with higher data rate when in proximity of certain equipment, compared to during longer distance travel between two work locations. Similarly, the UE may provide captured footage with higher data rate only during specific times of the day, or for a specific period of time after another trigger occurs. The time and geo-spatial triggers may be combined with each other and other types of triggers such as those using DL flow conditions.

The CCG rule provided to the UE in this case may be used to implement functionality such as: 1) based on determining that the condition of the UE location, projected path, speed, or proximity to other UEs meets the provided criteria, each of the QFIs of the CCG UL data flows may be changed to specified values. Similarly, the QFI change of the UL data flows may occur at specified times, after a certain amount of time after arriving to a location, and the like; 2) based on determining that the condition of the UE location, projected path, speed, or proximity to other UEs meets the provided criteria, the current CCG rule may be replaced by another, specified rule. Similarly, the rule change may occur at specified times, after a certain amount of time after arriving to a location, and the like.

Another example may describe UL flow coordination based on RCM. In the present example, the CCG trigger may be provided via a specific marker termed Reflective CCG Marker (RCM) in one of the DL data flows from the set provided in the CCG. In this example, the list of coordination commands to be applied by the UE may involve QFI changes for one or more UL data flows from the set provided in the CCG.

Use of RCM applies, in example scenarios in which a DL data flow may be used to provide coordination information to the UE for one or more UL data flows, e.g., by including all of them in the same CCG. RCM may be inserted a DL data packet by the source of the data packet. For example, the source of the data packet may be another UE or an AF. Alternatively, the RCM may be inserted by the UPF. The UPF may use PCC rules to detect when insertion of the RCM is needed. Another UE or AF may use CCG rules (actions) to determine when the insertion of the RCM is needed. Use of RCM may apply to a scenario with DL data and multiple UL data flows for collected video, audio, ambient and haptic data collected from the same apparatus, similar to a previously covered scenario. The present example may allow the server side to provide the triggers for pre-established coordination parameters. The pre-established coordination parameters may be sent to the UE via the coordination commands of multiple CCG Policies. The change between policies may be triggered by the server and signaled in the DL through the RCM.

The CCG rule provided to the UE in this case may be used to implement functionality such as: 1) based on a determination that the RCM with a specified value is received on a specific DL CCG flow, each of the QFIs of the CCG UL data flows may be changed to reflect QoS with the latency, data rate or QFI of the DL. Alternatively, the UE may use the trigger to measure a specified CSM DL RX-delta measurement and use the value for UL flow synchronization; 2) based on a determination that the RCM with a specified value is received on a specific DL CCG flow the CCG rule in effect may be changed for another specified CCG rule. Alternatively, the UE may change synchronization rules. Note that the change of rule may result in additional actions being taken by the UE, according to the new rule; 3) based on a determination that the RCM with a specified value is received on a specific DL CCG flow the UE may start or stop a flow, PDU, or the like. Alternatively, the UE may start or stop flow synchronization or CSM measurements.

Another example may describe flow synchronization assistance. In this example, the CCG trigger may be based on the characteristics of one or more DL data flows from the set provided in the CCG. In this example, a synchronization rule may be provided. The commands may be applied by the UE involves synchronization of two or more UL data flows.

The CCG rule provided to the UE in this case may provide rules to implement functionality such as: 1) based on a determination that a specified CSM UL arrival-delta measurement is met, the UE may delay or buffer coordinated data flows until the CSM UL TX-delta measurement specified is met; 2) based on a determination that a specified threshold is met for any of the CSM delta measurement, a report of the measurement may be sent to the RAN, UPF, CN, AF, its own UE applications, or other UE in the VN.

Systems and methods described herein may comprise a graphical user interface (GUI) that allows a user to select whether coordinated communications are enabled by the user for all or specific applications. For specific applications such as a VR gaming application, the GUI may also allow the user to select which other UEs it is willing to participate with in coordination of communication. The GUI may also allow the user to select requirements to be fulfilled or parameters to be optimized, which may be translated by the AF into CCG policy and rule inputs.

Based on a determination that the apparatus is acting based on certain communication coordination commands, the apparatus may display a pop-up message to the user. The pop-up message may indicate for example, that a QoS/QFI adjustment has been made for the purpose of communication coordination, resulting in a different Quality of Experience. The message may allow the user to select a desired level of Quality of Experience or simply to be informed of the service status.

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to comprise a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, apparatus remote controlling, bi-directional remote controlling, personal cloud computing, video streaming, wireless cloud-based office, first responder connectivity, automotive recall, disaster alerts, real-time gaming, multi-person video calls, autonomous driving, augmented reality, tactile internet, virtual reality, home automation, robotics, and aerial drones to name a few. All of these use cases and others are contemplated herein.

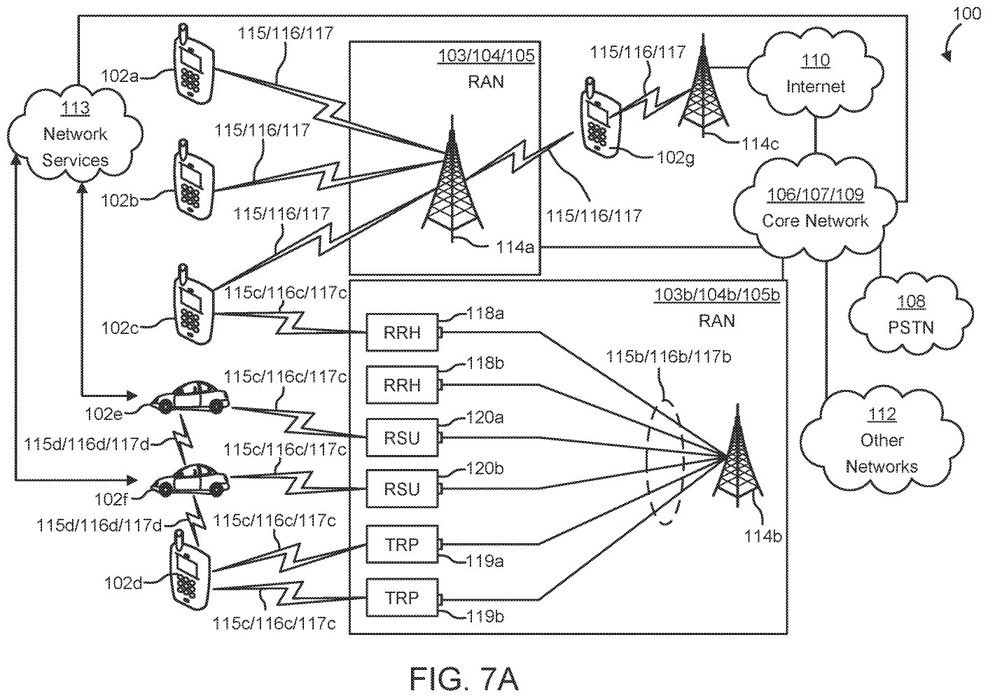

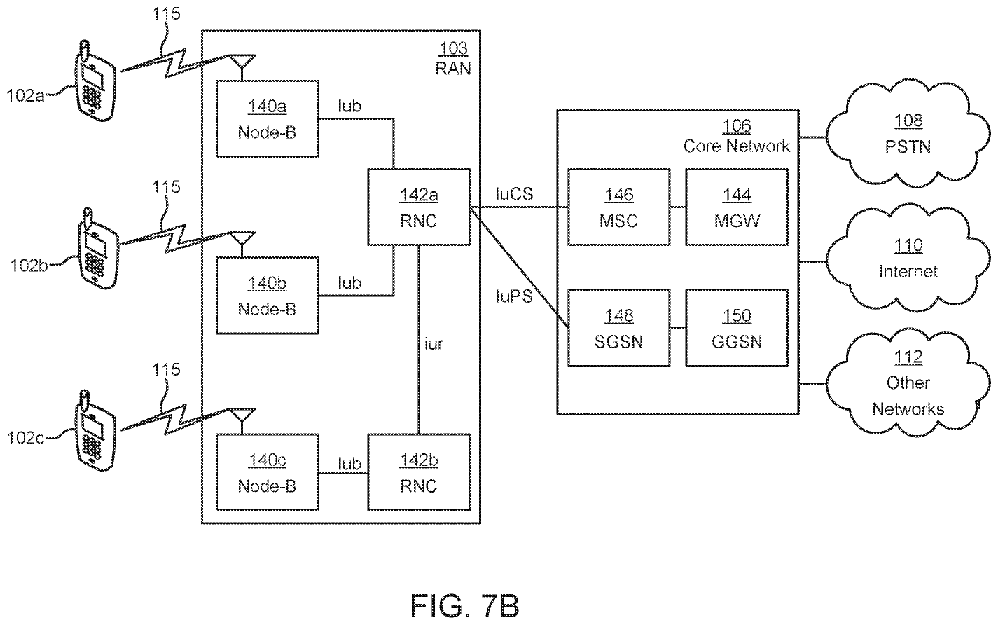

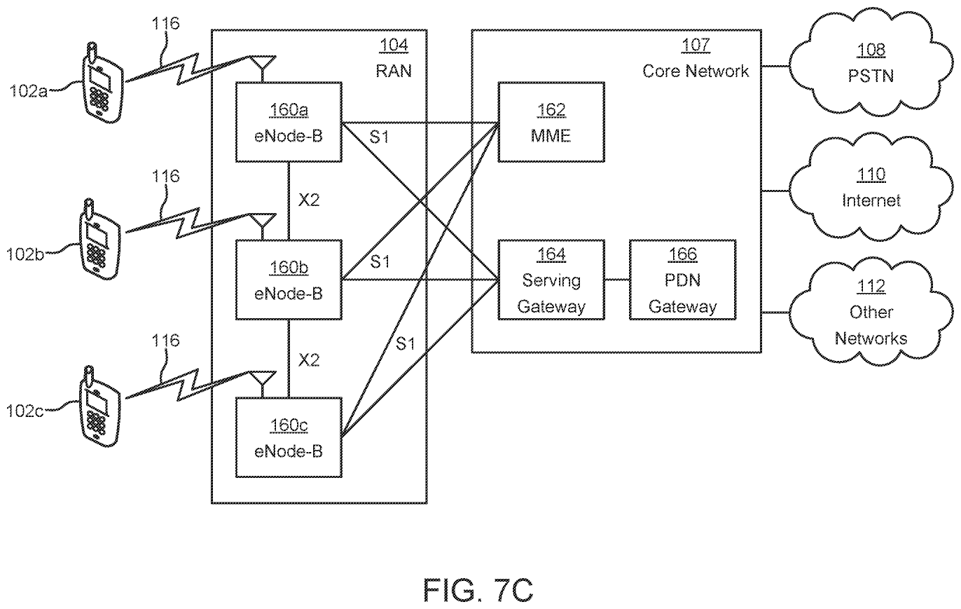

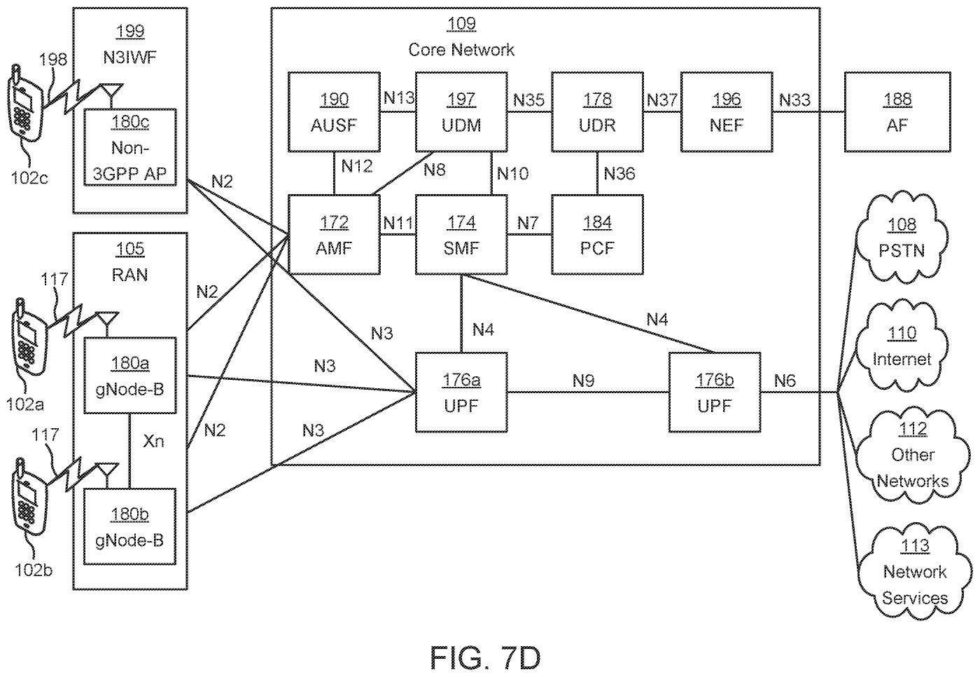

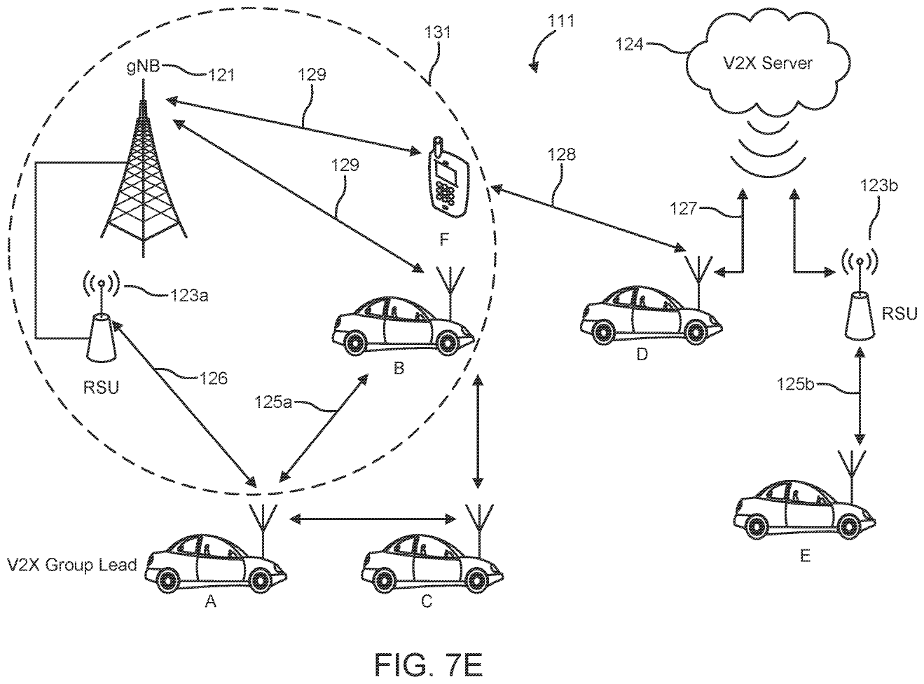

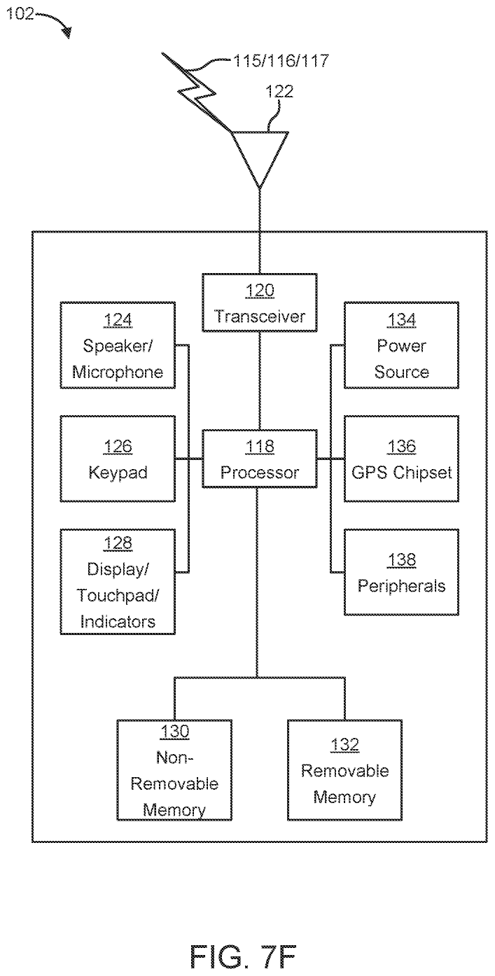

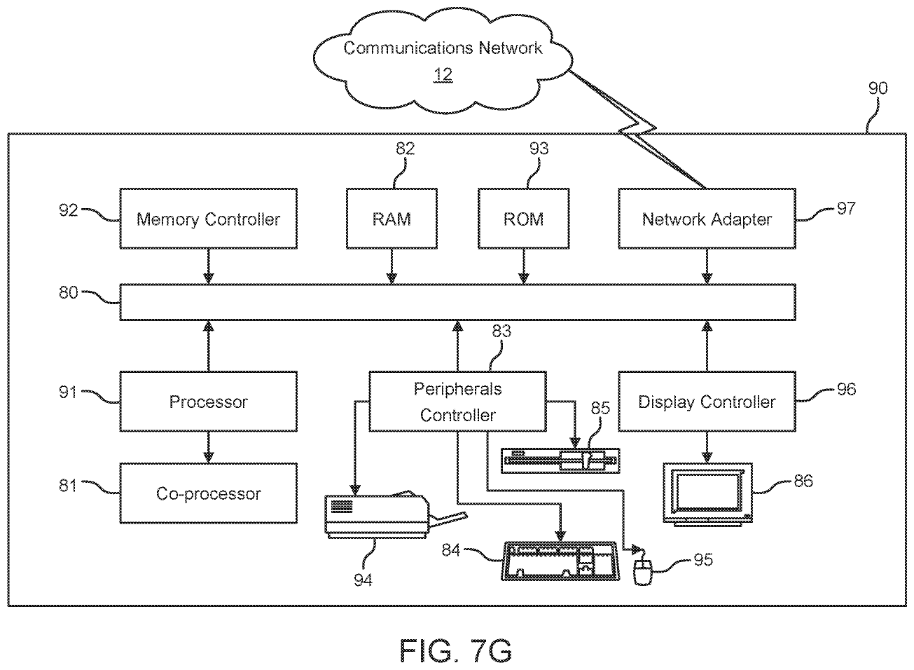

FIG. 7A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, edge computing, or the like.

It will be appreciated that the concepts disclosed herein may be used with any number of WTRUs, base stations, networks, and/or network elements. Each of the WTRUs 102 may be any type of apparatus configured to operate and/or communicate in a wireless environment. In the example of FIG. 7A, each of the WTRUs 102 is depicted in FIGS. 7A-7E as a hand-held wireless communications apparatus. It is understood that with the wide variety of use cases contemplated for wireless communications, each WTRU may comprise or be included in any type of apparatus configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable apparatus such as a smart watch or smart clothing, a medical or eHealth apparatus, a robot, industrial equipment, a drone, a vehicle such as a car, bus or truck, a train, or an airplane, and the like.

The communications system 100 may also include a base station 114a and a base station 114b. In the example of FIG. 7A, each base stations 114a and 114b is depicted as a single element. In practice, the base stations 114a and 114b may include any number of interconnected base stations and/or network elements. Base stations 114a may be any type of apparatus configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of apparatus configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of apparatus configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of apparatus configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of apparatus configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, or the like. Similarly, the base station 114b may be part of the RAN 103b/104b/105b, which may also include other base stations and/or network elements (not shown), such as a BSC, a RNC, relay nodes, or the like. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for instance.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, or the like.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, or the like.) or wireless communication link (e.g., RF, microwave, IR, UV, visible light, cmWave, mmWave, or the like.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, or the like.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, or the like.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, or the like.) Similarly, the 3GPP NR technology may include NR V2X technologies and interfaces (such as Sidelink communications, or the like.)

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 7A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, or the like.) to establish a picocell or femtocell. As shown in FIG. 7A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VoIP) services to one or more of the WTRUs 102. For example, the core network 106/107/109 may provide call control, billing services, mobile location-based services, pre-paid calling, Internet connectivity, packet data network connectivity, Ethernet connectivity, video distribution, and/or perform high-level security functions, such as user authentication.

Although not shown in FIG. 7A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and apparatuses that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 7A may be configured to communicate with the base station 114a, which may employ a cellular-based radio technology, and with the base station 114c, which may employ an IEEE 802 radio technology.

Although not shown in FIG. 7A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 7B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 7B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 7B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 7B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications apparatuses.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled apparatuses.

The core network 106 may also be connected to the other networks 112, which may include other wired or wireless networks that are owned and/or operated by other service providers.

FIG. 7C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 7C, the eNode-Bs 160a, 160b, and 160c may communicate with one another over an X2 interface.

The core network 107 shown in FIG. 7C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled apparatuses.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications apparatuses. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 7D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 7D, the gNode-Bs 180a and 180b may communicate with one another over an Xn interface, for example.

The core network 109 shown in FIG. 7D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 7G.

In the example of FIG. 7D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not comprise all of these elements, may comprise additional elements, and may comprise multiple instances of each of these elements. FIG. 7D shows that network functions directly connect to one another, however, it should be appreciated that they may communicate via routing agents such as a diameter routing agent or message buses.

In the example of FIG. 7D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, or the like.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 7D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other apparatuses. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 7D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators may use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 7D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, or the like.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIGS. 7A, 7C, 7D, and 7E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 7A, 7B, 7C, 7D, and 7E are provided by way of example only, and it is understood that the subject matter disclosed and claimed herein may be embodied or implemented in any similar communication system, whether presently defined or defined in the future.

FIG. 7E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 7E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 7E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 7F is a block diagram of an example apparatus WTRU 102 that may be configured for wireless communications and operations in accordance with the systems, methods, and apparatuses described herein, such as a WTRU 102 of FIG. 7A, 7B, 7C, 7D, or 7E. As shown in FIG. 7F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 7F and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 7F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 7A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 7F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage apparatus. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable apparatus for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method.

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration apparatus, a television transceiver, a hands free headset, a Bluetooth® module, a frequency modulated (FM) radio unit, a digital music player, a media player, a video game player module, an Internet browser, and the like.

The WTRU 102 may be included in other apparatuses, such as a sensor, consumer electronics, a wearable apparatus such as a smart watch or smart clothing, a medical or eHealth apparatus, a robot, industrial equipment, a drone, a vehicle such as a car, truck, train, or an airplane. The WTRU 102 may connect to other components, modules, or systems of such apparatuses via one or more interconnect interfaces, such as an interconnect interface that may comprise one of the peripherals 138.

FIG. 7G is a block diagram of an exemplary computing system 90 in which one or more apparatuses of the communications networks illustrated in FIGS. 7A, 7C, 7D and 7E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware apparatuses. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or apparatus, such as the RAN 103/104/105, Core Network 106/107/109, PSTN 108, Internet 110, WTRUs 102, or Other Networks 112 of FIGS. 7A, 7B, 7C, 7D, and 7E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage apparatuses, or any other tangible or physical medium which may be used to store the desired information, and which may be accessed by a computing system.

What is claimed is:

1. A method comprising:
receiving, by a non-access stratum (NAS) layer of a wireless transmit/receive unit (WTRU) and from an application server, a coordination identifier;
sending, by the WTRU and to a core network entity, a request to establish a protocol data unit (PDU) session, wherein the request comprises the coordination identifier;
receiving, by the WTRU, configuration information associated with the coordination identifier and the PDU session, wherein the configuration information comprises one or more rules associated with the PDU session that are to be coordinated with one or more rules associated with other PDU sessions; and
receiving, by the WTRU, from the core network entity, a message indicating establishment of the PDU session.

2. The method of claim 1, wherein the coordination identifier is not received from the application server, and wherein the method further comprises determining, by the WTRU, the coordination identifier using a user route selection policy (URSP) rule.

3. The method of claim 1, wherein at least one of the one or more rules associated with the PDU session comprises information indicating an action and a trigger condition associated with the action, wherein the trigger condition is used by the WTRU to determine when to perform the action on a coordinated data flow.

4. The method of claim 3, wherein the trigger condition comprises one or more of: a latency threshold, an indication of a location of the WTRU, a speed of the WTRU, or a proximity of the WTRU to other WTRUs.

5. The method of claim 3, wherein the action comprises one or more of: changing quality of service (QoS) markings associated with the coordinated data flow, applying a delay to the coordinated data flow, performing a measurement on the coordinated data flow, or buffering the coordinated data flow.

6. The method of claim 1, wherein the core network entity comprises a session management function (SMF).

7. The method of claim 3, further comprising performing, based on detecting the trigger condition, the action on the coordinated data flow.

8. The method of claim 1, wherein the coordination identifier is received by an application on the WTRU, and wherein the application sends the coordination identifier to the NAS layer of the WTRU.

9. An apparatus comprising:
one or more processors; and
memory storing instructions that, when executed by the one or more processors, cause the apparatus to:
receive, by a non-access stratum (NAS) layer associated with the apparatus and from an application server, a coordination identifier;
send, by the apparatus and to a core network entity, a request to establish a protocol data unit (PDU) session, wherein the request comprises the coordination identifier;
receive, by the apparatus, configuration information associated with the coordination identifier and the PDU session, wherein the configuration information comprises one or more rules associated with the PDU session that are to be coordinated with one or more rules associated with other PDU sessions; and
receive, from the core network entity, a message indicating establishment of the PDU session.

10. The apparatus of claim 9, wherein the coordination identifier is not received from the application server, and wherein the instructions further cause the apparatus to determine the coordination identifier using a user route selection policy (URSP) rule.

11. The apparatus of claim 9, wherein at least one of the one or more rules associated with the PDU session comprises information indicating an action and a trigger condition associated with the action, wherein the trigger condition is used by the apparatus to determine when to perform the action on a coordinated data flow.

12. The apparatus of claim 11, wherein the trigger condition comprises one or more of: a latency threshold, an indication of a location of the apparatus, a speed of the apparatus, or a proximity of the apparatus to other apparatuses.

13. The apparatus of claim 11, wherein the action comprises one or more of: changing quality of service (QoS) markings associated with the coordinated data flow, applying a delay to the coordinated data flow, performing a measurement on the coordinated data flow, or buffering the coordinated data flow.

14. The apparatus of claim 9, wherein the core network entity is a session management function (SMF).

15. The apparatus of claim 11, wherein the instructions further cause the apparatus to, based on detecting the trigger condition, perform the action on the coordinated data flow.

16. The apparatus of claim 9, wherein the coordination identifier is received by an application associated with the apparatus, and wherein the application sends the coordination identifier to the NAS layer of the WTRU.
